(19) United States
(12) Patent Application Publication
(10) Pub. No.: US 2010/0001475 A1
(43) Pub. Date: Jan. 7, 2010

(54) Piston ring seal

(76) Inventor: Robert Janian, Encino, CA (US)

Correspondence Address: ROBERT JANIAN, 3845 BALLINA CANYON ROAD, ENCINO, CA, 91436, US

(21) Appl. No.: 12/217,254

(22) Filed: Jul. 3, 2008

(51) Int. Cl. F16J 9/06

(52) U.S. Cl. 277/460; 267/1.5

(57) ABSTRACT

This invention describes a piston ring consisted of a “C” shaped spiraled wire acting as an expander for a seal ring of a softer material such as Teflon or Nylon; also acting as a split sealing device between two adjacent surfaces.

### FIELD OF THE INVENTION

This invention relates to mechanical seals in which the sealing element is a split cylindrical ring with an inner metallic expander providing a resilient force to energize ring for sealing the passage between two adjacent surfaces.

### BACKGROUND OF THE INVENTION

Split piston ring seals are typically made of polymeric Polyamide plastics such as Vespels, Peek, PTFE and Nylons where the split section of the seal is a “Z” shaped cut. This ring is expanded to be energized by a “C” shaped metallic spring which expands ring diameter larger than it's sealing bore surface and when it is pressed inside this bore diameter it provides sealing force at the point of contact between seal ring and its surface it comes in contact with.

Piston rings in variety of sizes are increasingly being used for a range of applications as dynamic sealing elements. They are exposed to high and low temperatures and pressures along with corrosive media and as the ring slides inside housing bore in reciprocating motion in order to compensate and makeup for this wear the “C” shaped spring which is inserted inside piston ring to compensate for wear as it reciprocates inside housing bore. Some cylinder bores have pressure holes drilled through their wall and whenever these holes coincide with the “Z” cut split section of ring create leak path and in order to prevent this leakage the seal ring has to be clocked so that this cut will always stay on the opposite side of holes in the cylinder wall, this invention makes it possible to prevent seal ring from rotating inside the housing bore.

A number of spring energizers are used to expand seal rings. As for example my prior U.S. Pat. No. 4,133,542 on configuration and method of making springs, my other prior U.S. Pat. Nos. 4,508,356 and 4,939,830, and 7,159,857 and SPRINGCLIP RING U.S. Pat. No. 6,419,236 which could also be utilized in conjunction with seal ring inside diameter. In order to minimize leak path through split “Z” cut section, this invention, also, makes it possible to close the seal ring gap at the split by simply offset spring ring ends so that it exerts longitudinal forces opposite each other at the split ends of seal ring to close end gap to minimize leakage.

### SUMMARY OF THE INVENTION

The object of this invention is to provide an improved spring energizer that overcomes the deficiencies of the prior art. Thus, a steel wire of variety cross sections is coiled to specific diameters and cut to individual rings then open ends to a desired gap, when inserted inside the split seal ring groove it's ends separate, thus giving necessary contact force to provide sealing between two adjacent surfaces it comes in contact. Spring ring ends are separated longitudinally away from each other so that ends are not collinear and when installed inside seal ring groove it will provide opposite forces towards centerline to close gap at the “Z” cut portion of seal ring thus minimizing leak path.

### DRAWING

FIG. 1 is frontal view of piston ring seal assembly and spring ring showing split “Z” cut pattern.

FIG. 2 is showing side view of same assembly with ring section and split “Z” cut

FIG. 3 demonstrates piston ring assembly with two spring rings.

FIG. 4 is side view of seal ring assembly with two spring rings and “Z” cut pattern.

FIG. 5 is sectional view of seal ring installed inside housing bore where acting as a seal between two adjacent surfaces.

FIG. 6 is frontal view of seal ring assembly where end of spring ring is bent towards ring center to act as a clocking device.

FIG. 7 is spring ring of FIG. 6 by itself in a free state.

FIG. 8 is cross sectional view of FIG. 7 seal ring assembly.

FIG. 9 is frontal view of split spring ring without clocking feature.

FIG. 10 is side view of spring ring in FIG. 9 showing ends with longitudinal offset.

FIG. 11 is showing cross sectional view of seal ring assembly installed inside sealing gland with clocking feature.

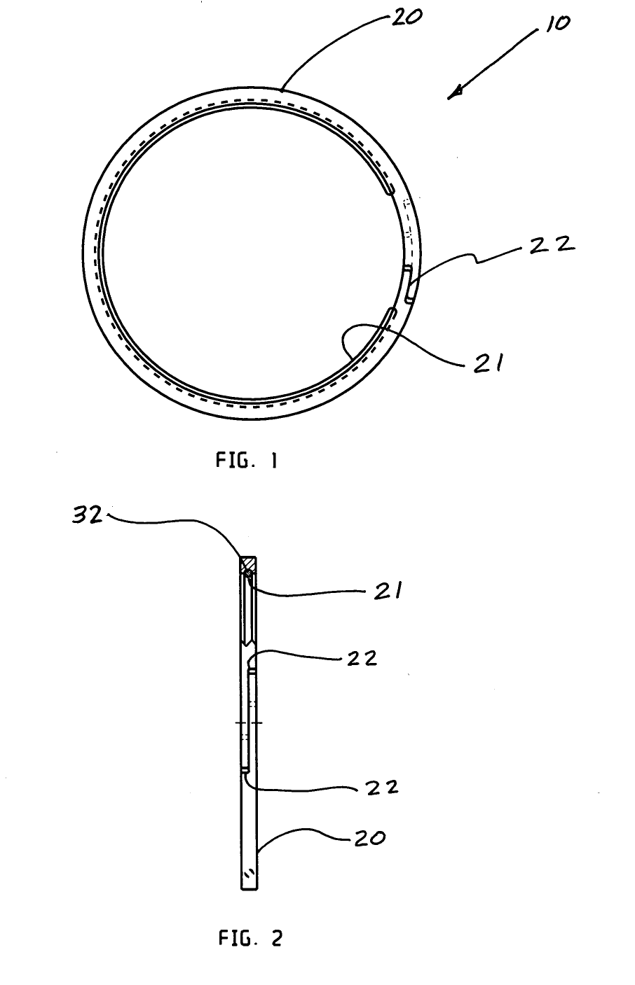

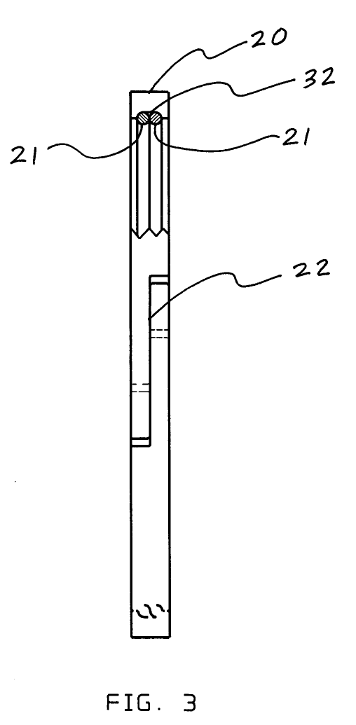

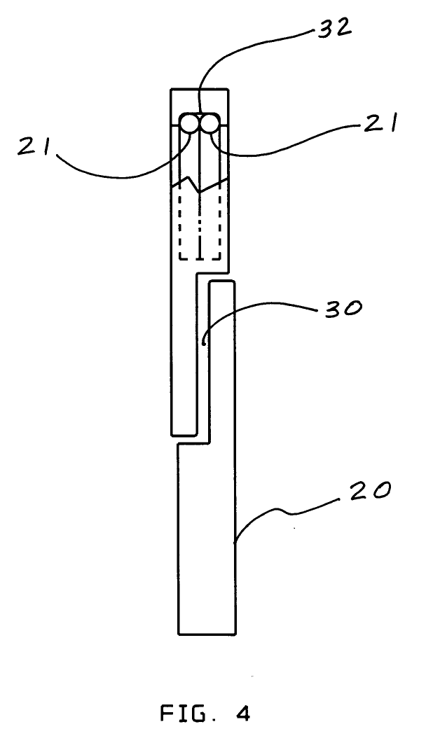

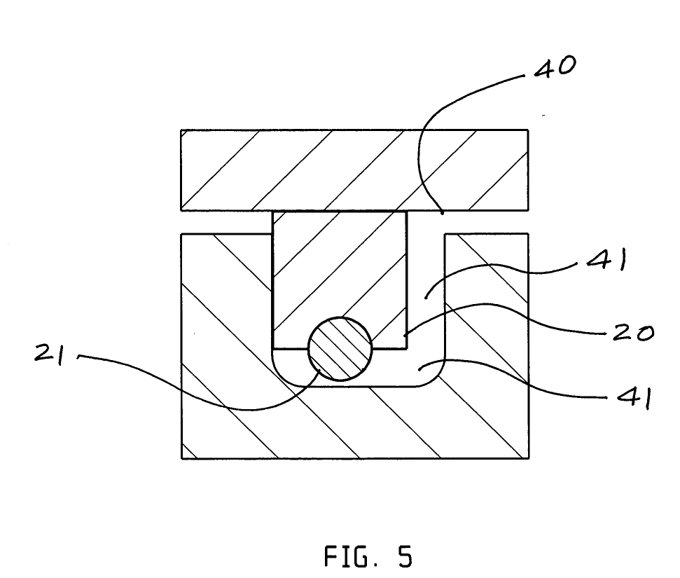

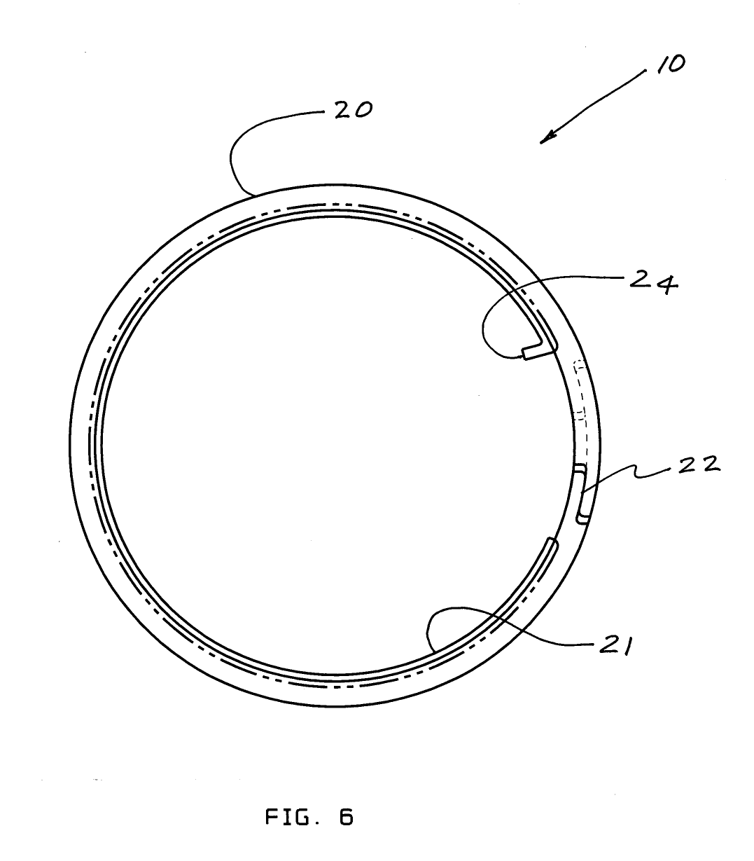

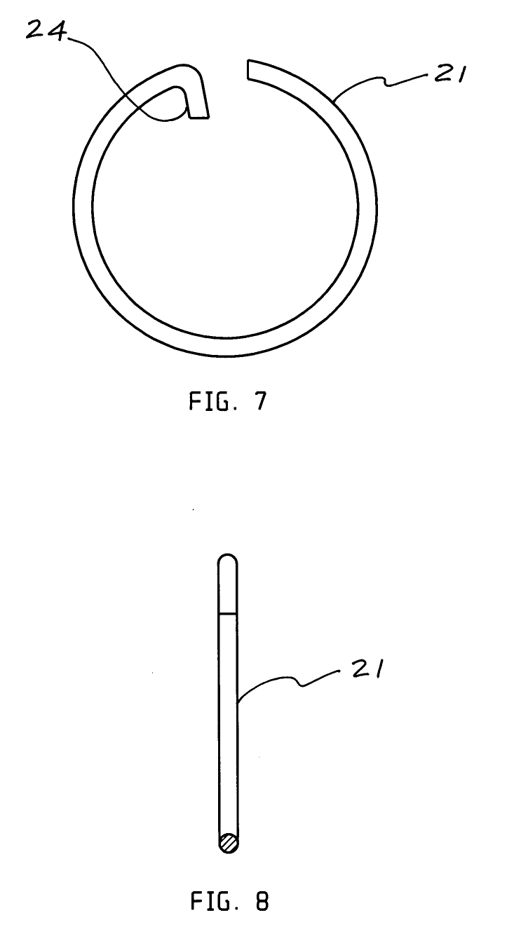

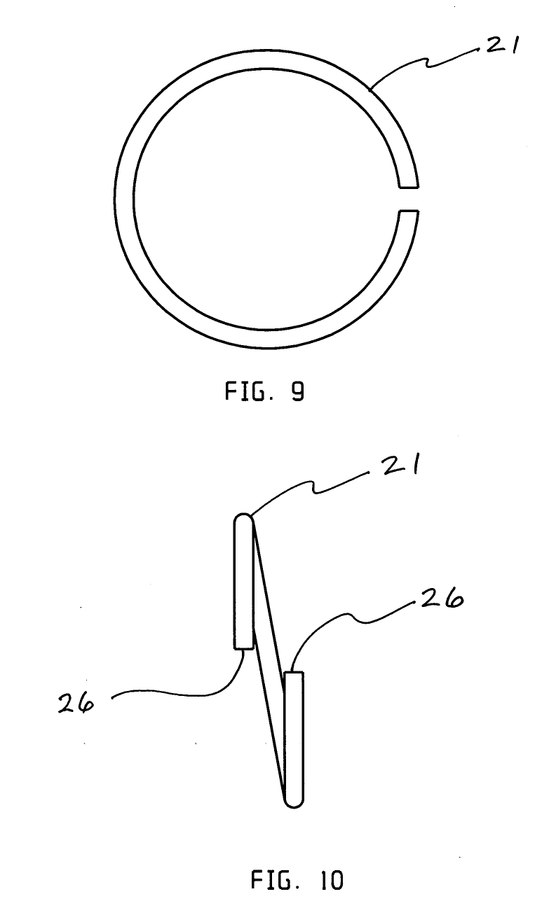

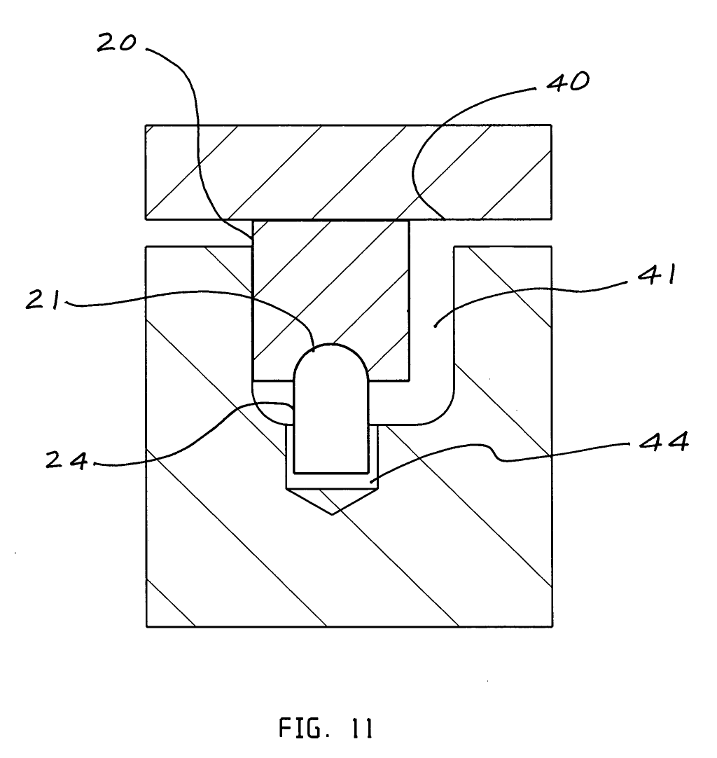

### DESCRIPTION OF THE PREFERRED EMBODIMENTS

Referring to the drawings, the piston seal ring assembly 10 consists of an outer seal ring 20 having an internal groove 32 and spring ring 21, the preferred form of seal ring 20 is a true circle with a split “Z” cut 22 where spring ring 21 is nested inside groove 32 beginning and ending at both ends of split cut 22, this creates an outwardly force along circumference of seal ring 20 resulting a larger diameter than it's original and when it is installed into gland cavity 41 and bore 40 creating a seal between two adjacent surfaces of bore 40. In the same manner, spring ring 21 is formed so that its ends 26 are pulled apart longitudinally and when installed inside cavity 32 it creates forces opposite to gap opening 30 bringing them closer together and minimizing leak path from one side to another. Spring ring 21 may also be bent inward, 24, towards center of its diameter and when it is inserted inside drilled hole 44 located inside groove cavity 41 this will prevent seal ring 10 from rotating inside gland cavity 41.

What is claimed:

1. A resilient “C” shaped spring, comprising:
A first substantially round wire strip element coiled

2. The resilient spring of claim 1 is made of resilient metal.

3. A resilient spring of claim 1 where ends are offset longitudinally.

4. The resilient spring of claim 1, where portion of one end of spring is bent towards its center.

5. The resilient spring of claim 4 ends are separated to increase its overall diameter from its original size.

6. Resilient spring of claim 1 is nested inside seal ring groove cavity.

7. A seal ring element comprising a defined inner groove for retaining split spring ring.

8. The seal ring element of claim 7 may retain more than one spring ring inside its inner retaining groove.

9. Where said defined groove beginning and ending at both sides of split “Z” cut.
